(19) United States
(12) Patent Application Publication
(10) Pub. No.: US 2007/0190313 A1
(43) Pub. Date: Aug. 16, 2007

(54) Omnidirectionally reflective composite and process

(76) Inventor: Kenneth Willemse, Harsens Island, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/338,153

(22) Filed: Jan. 24, 2006

(51) Int. Cl. B32B 18/00; B41M 1/12

(52) U.S. Cl. 428/325; 428/335; 101/129

(57) ABSTRACT

An omnidirectionally reflective composite that includes a reflective carrier material and a substrate. The reflective material has two primary components: a carrier medium, such as clear ink, and minute reflective particles, such as particles of mirrored glass. By suitable selection of a carrier medium and the particle, the reflective material imbues the substrate with a lustrous or pearlescent appearance, yet is durable in that it has abrasive characteristics that are akin to a fine grade of sand paper. To make the disclosed composite, ground mirrored glass is added to a carrier medium. The mixture is agitated to create a suspension of glass-impregnated carrier (“GIC”). The GIC is applied to the substrate through a silk screen so that an appropriate impression is made on the substrate. After drying, a glass-impregnated carrier-laden substrate is formed.

### BACKGROUND OF THE INVENTION

1. Field of the Invention

The invention relates to an omnidirectionally reflective composite and process by which it can be prepared.

2. Background Art

The art of silk screening is generally well known. One of the difficulties in conventional processes is that it would sometimes be desirable to be able to apply a large diameter particle size of highly reflective material through the fine silk screen to a substrate in order to create a vibrant, lustrous appearance. However, one of the difficulties has been that the average size of particles having desirable optical characteristics has been too great to pass through the mesh of conventional silk screens.

Among the art identified in a pre-application search of the following U.S. references: U.S. Pat. No. 4,328,274, issued to Tarbutton et al., filed May 4, 1982; U.S. Pat. No. 4,856,931, issued to Bollag, filed Aug. 15, 1989; U.S. Pat. No. 5,380,549, issued to Harvison, filed Jan. 10, 1995; U.S. Pat. No. 5,897,914, issued to DePriest, filed Apr. 27, 1999; U.S. Pat. No. 6,180,228 B1, issued to Mueller et al., filed Jan. 30, 2001; U.S. Pat. No. 6,368,660 B1, issued to Stoffers et al., filed Apr. 9, 2002; and U.S. Pat. No. 6,479,142 B1, issued to Condon et al., filed Nov. 12, 2002.

### SUMMARY OF THE INVENTION

An omnidirectionally reflective composite includes a reflective carrier material and a substrate. The reflective material has two primary components: a carrier medium, such as clear ink, and minute reflective particles, such as particles of mirrored glass.

By suitable selection of a carrier medium and the particle, the reflective material imbues the substrate with a lustrous or pearlescent appearance, yet is durable in that it has abrasive characteristics that are akin to a fine grade of sand paper.

To make the disclosed composite, ground mirrored glass is added to the carrier medium. The mixture is agitated to create a suspension of glass-impregnated carrier (“GIC”). The GIC is applied to the substrate, preferably through a silk screen so that an appropriate impression is made on the substrate. After drying, a glass-impregnated carrier-laden substrate is formed.

### BRIEF DESCRIPTION OF THE DRAWINGS

FIG. 1 is a cross-sectional view of an omnidirectionally reflective product according to the invention; and

FIG. 2 is a process flow diagram which illustrates the main steps in practicing the inventive process.

### DETAILED DESCRIPTION OF THE PREFERRED EMBODIMENT(S)

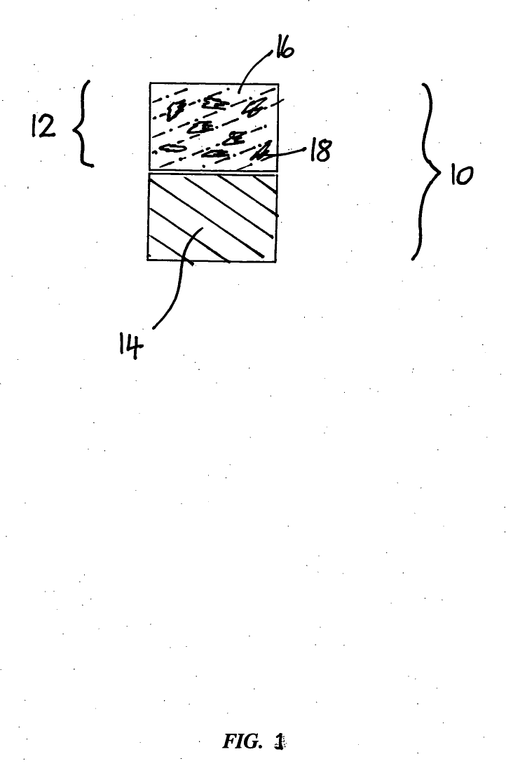

FIG. 1 is a schematic cross-sectional view of an omnidirectionally reflective composite 10. The composite 10 includes a reflective carrier material 12 and a substrate 14. For the reasons discussed below, the reflective material has omnidirectional optical characteristics in that it reflects and refracts incident light in many directions—not merely reflecting light back along a path first traveled by an incident beam.

The reflective material has two primary components: a carrier medium 16—such as clear ink—and minute reflective particles 18—such as particles of mirrored glass. In some embodiments of the invention, they have a particle size ranging between 1 and 13 microns; or 1-45 microns; or 1-100 microns. On average, preferably, the average particle size is less than about 15 microns. In one embodiment, the thickness of one coat of the reflective material is about 0.003 inches. Preferably, in the case of mirrored glass, the particles are recycled. One supplier is Bead Brite Research LLC of Coconut Creek, Fla.

By suitable selection of the carrier medium 16 and the particles 18, the reflective material has a lustrous or pearlescent appearance, yet is durable in that it has abrasive characteristics also that are akin to a fine grade of sandpaper (e.g. 400 grit).

The substrate 14 is a material selected from the group consisting of rubber, paper, wood, textiles, glass, leather, plastic, metals, alloys, vinyl, decals, striping, TYVEK HOMEWRAP® (a non-woven barrier material sold in sheeting and used in the construction industry to protect walls and roofs of structures from wind and moisture) and combinations thereof. The substrate 14 may be colored (for example in orange, silver or blue), or may lack color.

The carrier medium 16 in some embodiments is a clear ink, such as that available from Nazdar of Shawnee, Kans. In general, any conventional, solvent UV-resin based screen printing ink may be suitable, depending upon the substrate and the method by which the reflective material 12 is applied to the substrate. If desired, solvent-based inks can be thinned by such products as Nazdar S230 to suit the production characteristics required for the particular silk screen machine to be used.

If desired, materials other than or in addition to the mirrored glass particles 18 can be mixed with the carrier 16 to produce the reflective material. Such materials can include, for example, metallic particles, micas, pearl, HELICONE® (which tends to impart a gold tone to an orange color). HELICONE® is available from the H.W. Sands Corporation of Jupiter, Fla. The HELICONE® product enables one to adjust appearance of the composite over a broad range by combination with a complementary pigments and additives. The material is reported to be suitable for use on a wide range of substrates, including metal, plastic, textiles, and leather. Preferably, a clear coat is applied on top of a HELICONE® layer for high gloss or exterior applications. In practice, it is desirable that the product be used with UV stabilizers that are effective through the UVA range of 320-400 n.m. and above when intended for exterior applications.

Matching reflective additives to pigments such as (1) mica, (2) xerlic, (3) aluminum and other pigments produces a specular brilliance that is desirable in automotive, aerospace and other related industries. These additives reflect IR wave lengths to produce signature coatings, while reflecting heat.

One exemplary formulation is:

| | | | | | |
|---|---|---|---|---|---|
| Glass | 6 | tsp. | 1–100 | μm | Chrome Brite CB100 |
| | 3 | tsp. | 1–13 | μm | Chrome Brite CB4000 |
| Glitter | 2 | tsp. | 37 | μm | Chinese Silver |
| Enhance- | 1 | tsp. | 1–55 | μm | HELICONE ® HC Maple XS |
| ments | 1 | tsp. | 1–5 | μm | Chrome Brite |
| | 1 | tsp. | 1–40 | μm | Silver Xeric |

| | | | | |
|---|---|---|---|---|
| Carrier | 8 | oz. | Nazdar | System 2 Overprint Clear |
| Other | 1.5 | oz. | Nazdar | S230 Thinner |
| | 0.5 | oz. | Nazdar | S231 Retarder |

| | | | |
|---|---|---|---|
| Fabric | LE7-175-55 | Sefar | Precap |
| Squeegee | 70 Durometers | | |
| Blade | | | |

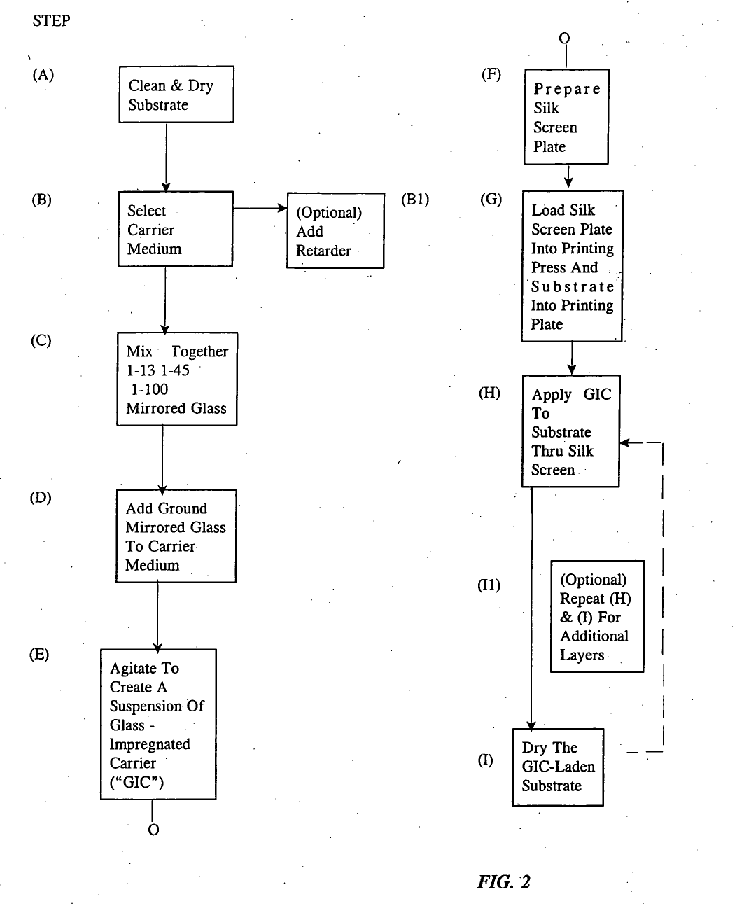

The main process steps (A-I) used in practicing the invention are depicted in FIG. 2. In step (A), the substrate is prepared by cleaning and drying. Step (B) involves selecting the carrier medium, such as clear ink. Optionally, in step (B1) a retarder may be added to delay the drying time of the ink. In step (C), mirrored glass is ground to a fine particle size. Step (D) involves mixing the ground glass particles with the carrier medium to create a scattered reflective characteristic.

To prepare the reflective material, in one example, ground glass particles were mixed with a clear ink, for example, in a proportion of ink to glass of about 35:65. In general, the amount and type of glass added to the ink depends on the desired appearance of the finished product.

Step (E) involves agitation to create a suspension and prevent settling of the glass in the carrier medium to prepare a glass-impregnated carrier (“GIC”). In step (F), a silk screen plate is prepared. This step involves selective removal from the silk screen of material, thereby leaving an outline that defines a boundary within which the GIC may pass in a subsequent step.

In step (G), the silk screen plate is loaded into a printing press. Next, the treated substrate is loaded into a printing plate.

Step (H) involves applying the GIC to the substrate through the silk screen. Finally, in step (I), the GIC-laden substrate is allowed to dry. Optionally, in (step I1), steps (H) and (I) are repeated if multiple layers are desired.

If desired, several coats of reflective material may be applied, after allowing a previously applied coating first to dry. As indicated earlier, the average single coating thickness is about 0.003 inches.

In the silk-screening process referenced above, step (H) involves applying the GIC to the substrate. One way to do this is to begin with a rectangular frame that has a surface area exceeding that to be treated. Over this frame, a piece of shear fabric (such as silk or polyester) is tightly stretched, thus forming a screen. Over the shear fabric is placed a thin layer of emulsion which is sensitive to ultraviolet light. Then the holes can be prepared by a suitable application of light energy.

Next, the substrate is placed on a flat supporting surface (printing table) and the screen is pressed onto the substrate. By coating the screen with the reflective material using, for example, a sponge or squeegee, the reflective material is caused to flow through the screen and onto the substrate.

To prepare multi-color designs, steps (H)-(I1) can be repeated multiple times, preferably starting with the lightest color and moving up to the darkest.

In one example, screens were provided with a monofilament polyester. Mesh count ranged from 123 to 230. A stencil was prepared from an emulsion that was directly applied to the fabric and dried. Next, positive art was placed and mounted on the substrate side of the screen. The screen was then exposed to ultraviolet light which hardened the emulsion, but not the art. Finally, the screen was power washed, thereby leaving negative art and a hard stencil. The GIC was then pushed through the stencil onto the substrate using a 60-80 durometer squeegee. The product was then placed on a rack until the ink cured.

Alternatively, an iron-on transfer technique can be used. In that technique, the reflective material is adhered to a suitable substrate by the application of thermal energy through thin thermoplastic inks. Upon heating, the reflective material becomes bonded onto the substrate.

Through either process, a vinyl film substrate 14 can be enhanced with optically brilliant additives 18. One result is a product that has functional and aesthetic benefits-both for performance and safety. By distributing brilliant mirrored particles, the finish added to the substrate effectively directs incident illumination omnidirectionally. Furthermore, for nighttime conditions, these particles produce a highly visible, scattered reflective finish that promotes safety. Thus, the invention involves matching the micron sizes of additives to silk screening mesh sizes, and determining process parameters that produce a specular metallic appearance and uniformity of coating to create a brilliant, bright reflectivity.

Benefits can be obtained by producing a mat finish over vinyl film that improves resistance to markings and imbues the substrate with heat transfer characteristics that have not been equaled in past vinyl materials.

The inventive process can be used, for instance, to apply three coats: (1) a base coat to the substrate, (2) a silk screen mid-coat of reflective material, and (3) an optional final clear coat finish. The final clear coat finish can be (1) spray coated, (2) roller coated, and/or (3) flood-silkscreen coated to produce a distinct image.

Applications of the invention include: (1) road signs, (2) school bus graphics, (3) airport runways, (4) enhanced automobile hoods, side panels and bumpers and other applications that necessitate highly visible reflective properties, such as in situations (e.g. on aircraft and military materiel) where a signature or other form of ready identification is desirable.

In one approach, the substrate 14 is cleaned, and then an adhesive is applied. The adhesive may be a material, such as Control Tack (available from the 3M Company) or A6 Vinyl (available from Avery). To the adhesive, a vinyl layer is applied. The reflective material 12 is then applied, preferably through a silk screening process to the vinyl. Optionally, a clear coat is added on top of the reflective layer 12.

In most embodiments, the chemical properties of the reflective material 12 and substrate 14 are such that they tend to bond together in step (H) after the reflective material 12 is applied to the substrate 14. In such situations, there is no need for an adhesive to be applied between the substrate and the reflective material.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An omnidirectionally reflective composite comprising:
a reflective carrier material; and
a substrate,
wherein the reflective carrier material includes a carrier medium and reflective particles that are distributed within the carrier medium, the reflective material having the characteristic of omnidirectional reflection of incident light.

2. The composite of claim 1 wherein the reflective material includes particles of mirrored glass.

3. The composite of claim 2 wherein the reflective particles have a particle size ranging between 1 and 13 microns.

4. The composite of claim 2 wherein the reflective particles have a particle size ranging between 1 and 45 microns.

5. The composite of claim 2 wherein the reflective particles have a particle size ranging between 1 and 100 microns.

6. The composite of claim 2 wherein the average particle size of the reflective material is less than about 15 microns.

7. The composite of claim 1 wherein the average thickness of the reflective material is about 0.003 inches.

8. The composite of claim 1 wherein the reflective material has an abrasive characteristic that is substantially similar to that of a fine grade of sand paper.

9. The composite of claim 1 wherein the reflective material as an abrasive characteristic that is substantially similar to that of 400 grit grade of sand paper.

10. The composite of claim 1 wherein the substrate is a material selected from the group consisting of rubber, paper, wood, textiles, glass, leather, plastic, metals, alloys, vinyl, decals, striping, TYVEK HOMEWRAP®, and combinations thereof.

11. The composite of claim 1 wherein the substrate has a color selected from the group consisting of orange, silver, blue, and mixtures thereof.

12. The composite of claim 1 wherein the carrier medium comprises a clear ink.

13. The composite of claim 1 wherein the reflective particles are selected from the group consisting of mirrored glass, metallics, micas, pearl, HELICONE®, and combinations thereof.

14. The composite of claim 13 further including a UV stabilizer that is effective through the a UVA range of 320-400 n.m. and above.

15. The composite of claim 1 wherein the reflective particles include those selected from the group consisting of mica, xerlic, aluminum, and mixtures thereof.

16. The composite of claim 1 further including one or more additional layers of reflective material.

17. The composite of claim 16 wherein the reflective material and the one or more layers of reflective material comprise different colors.

18. The composite of claim 1 wherein the substrate comprises a component selected from the group consisting of an automobile, an automobile hood, an automobile bumper, an automobile side panel, an aircraft, a military vehicle, a tractor, a road sign, a school bus, an airport runway, a road surface, and a motorcycle.

19. The composite of claim 1 further including a final clear coat finish that is applied to the reflective material.

20. A process for preparing a composite having omnidirectionally reflective properties, comprising the steps of:
(A) cleaning and drying a substrate;
(B) selecting a carrier medium;
(C) grinding mirrored glass;
(D) adding the ground mirrored glass to the carrier medium;
(E) agitating to create a suspension of glass-impregnated carrier;
(F) preparing a silk screen plate;
(G) loading the silk screen plate into a printing press and the substrate into the printing plate;
(H) applying the glass-impregnated carrier to the substrate through a silk screen; and
(I) drying the glass-impregnated carrier-laden substrate.

21. The process of claim 20 further comprising the step of:
(B1) adding a retarder to prolong the drying time of the carrier medium.

22. The process of claim 20 further comprising the step of:
(I1) repeating steps (H) and (I) to create additional layers on the substrate.

23. The process of claim 22 further comprising the step of:
adding a clear coat to the glass-impregnated carrier-laden substrate.

24. The process of claim 23 further comprising the steps of repeating steps (H)-(I1) with multiple colors.

25. The process of claim 23 wherein the step of applying a clear coat finish comprises a technique selected from the group consisting of spray coating, roller coating, and silk screening.

26. The process of claim 25 further comprising the step of applying an adhesive to the substrate before applying the reflective material.

27. The process of claim 26 further comprising the step of applying a vinyl layer to the adhesive layer and applying the reflective material.

28. The process of claim 27 further comprising the step of adding a clear coat on top of the reflective layer.

29. A process for preparing a composite having omnidirectionally reflective properties, comprising the steps of:
(A) adding a ground mirrored glass to a carrier medium to create a suspension of glass-impregnated carrier;
(B) and applying the glass-impregnated carrier to a substrate.
